(19) United States
(12) Patent Application Publication
(10) Pub. No.: US 2015/0361711 A1
(43) Pub. Date: Dec. 17, 2015

(54) METHOD AND SYSTEM FOR POSITIONING A VEHICLE DOOR

(71) Applicant: BROSE FAHRZEUGTEILE GMBH & CO. KOMMANDITGESELLSCHAFT, HALLSTADT, HALLSTADT (DE)

(72) Inventors: SVEN BAUMANN, BREITENBACH (DE); MARCO SEMINETH, BAD KOENIGSHOFEN (DE); BERTRAM BOPP, BAMBERG (DE)

(21) Appl. No.: 14/304,406

(22) Filed: Jun. 13, 2014

(51) Int. Cl. E05F 15/79; E05F 15/611; B60J 5/00; E05F 15/70

(52) U.S. Cl. CPC E05F 15/79; E05F 15/70; E05F 15/611; B60J 5/00; E05Y 2400/40; E05Y 2900/546

(57) ABSTRACT

A method and a system are provided for positioning a vehicle door being movable in an opening direction and a closing direction along a travel path between an open position and a closed position. The system includes a plurality of command units and an electric positioning device, the latter moving the vehicle door using a motor. According to the method, through the use of one or more of the command units, at least one opening command and at least one closing command are created and transmitted to the electric positioning device for causing the electric positioning device to move the vehicle door in the respective opening direction or closing direction. Through the use the electric positioning device, the commands are processed upon receipt by virtue of a given set of priority rules, in dependence on the direction of movement of the vehicle door specified by the respective command.

### BACKGROUND OF THE INVENTION

### Field of the Invention

The invention relates to a method for positioning a vehicle door, the vehicle door being movable in an opening direction and a closing direction along a travel path between an open position and a closed position. Furthermore, the invention relates to a system including a plurality of command units and an electric positioning device for positioning a vehicle door. In particular, the invention relates to a method and a system for positioning a side door or a tail gate of a passenger car.

Modern passenger cars are frequently equipped with electric positioning devices for automatically opening and closing vehicle doors such as side doors and tail gates. Usually, an electric positioning device of that kind can be controlled by a plurality of command units being operable to create an opening command or a closing command when activated by a user of the car. The command units may, inter alia, include a number of switches and buttons installed inside and outside the car. For instance, the plurality of command units provided for triggering the opening and closing of an automatically driven tail gate usually include one or more outer switches disposed at the tail gate, an inner switch disposed inside the car and a remote control button being provided at a car key. Furthermore, the plurality of command units may include a touch-free command unit. A touch-free command unit may be realized by a capacitive sensor configuration operable to create an opening command or closing command for the electric positioning device upon detection of a characteristic approximation of a hand or foot of a car user.

Some of the plurality of command units may be operable for creating only opening commands or for creating only closing commands while other command units of the plurality of command units may be operable for creating both opening commands and closing commands.

A severe disadvantage of prior systems is that, by using the plurality of command units attributed to one electric positioning device, conflicting commands may be created. For example, the opening of the tail gate may be triggered by a car user standing behind the car using the touch-free command unit and, still during the opening of the tail gate, a passenger sitting in the car may create a closing command by actuating the inner switch. That may lead to inconvenient or even dangerous situations such as a car user being pinched or trapped by the closing tail gate.

A conventional system for automatically moving a tail gate is known from German Patent Application DE 10 2012 014 243 A1. In order to avoid problems arising from conflicting commands created by a plurality of command units, different priorities are attributed to each of the plurality of command units such that the execution of a command given by a command unit of higher priority cannot be influenced by a command given by a command unit of lower priority.

Furthermore, a motor driven window lifter for a motor vehicle is known from German Patent Application DE 33 34 317 A1. The window lifter can be controlled by a primary switch and a secondary switch. The function of the primary switch is given priority over the function of the secondary switch.

### SUMMARY OF THE INVENTION

It is accordingly an object of the invention to provide a method and a system for positioning a vehicle door, which overcome the hereinafore-mentioned disadvantages of the heretofore-known methods and systems of this general type and which assure a secure, yet convenient usage of an electric positioning device for automatically opening and closing a vehicle door that can be controlled by a plurality of command units.

With the foregoing and other objects in view there is provided, in accordance with the invention, a method for positioning a vehicle door being movable in an opening direction and a closing direction along a travel path between an open position and a closed position. According to the method, at least one opening command and at least one closing command are created by one or more of a plurality of command units and transmitted to an electric positioning device for causing the electric positioning device to move the vehicle door in the respective opening direction or closing direction. Upon receipt, the commands are processed by the electric positioning device by virtue of a given set of priority rules, in dependence on the direction of movement of the vehicle door specified by the respective command. The step of processing a command includes a decision to be made by the electric positioning device upon receipt of the command whether or not the command is executed. The decision is made, by the electric positioning device, based on the priority rules. As mentioned above, the priority rules define the priority of a given command in dependence on the direction of movement of the vehicle door specified by the command, i.e. in dependence on whether the command is an opening command or a closing command. Preferably, in accordance with the priority rules, opening commands are executed with a higher priority than closing commands. On the other hand, preferably, the priority rules do not define priorities among the command units. Instead, in the preferred embodiment of the invention, corresponding commands (commands specifying the same direction of movement of the vehicle door) have equal priority, independently of the command unit by which they were created.

In a preferred embodiment of the invention, the priority rules are defined such that a closing command created by one of the command units is always overwritten with an opening command created by another one (in particular any other) of the command units, provided that the opening command is received by the electric positioning device later than the closing command, during execution of the latter. Thus, when during the closing of the vehicle door an opening command is created by any of the plurality of command units, the movement of the vehicle door is reversed and the vehicle door is opened.

In another preferred embodiment of the invention, the priority rules are defined such that a closing command created by one of the command units is always ignored, if it is received by the electric positioning device, under at least one further condition, after receiving an opening command created by another one of the command units. In other words, the closing command is ignored if it is received after the preceding opening command, and if, at the time the closing command is received, the least one further condition is met. As used herein, ignoring the closing command means that the closing command is not executed, i.e. that the vehicle door is not closed. Instead, in a preferred embodiment of the method, the opening of vehicle door, triggered by the preceding opening command, is continued upon receipt of the closing command. Alternatively, execution of the preceding opening command may be stopped by the electric positioning device upon receipt of the later closing command in accordance with the priority rules such that the movement of the vehicle door is halted or stopped.

Preferably, however, the priority rules are defined such that a closing command being received during execution of a prior opening command is not ignored if it is created by the same command unit that had created the prior opening command. In this case, the execution of the prior opening command is aborted, i.e. the opening of the tail gate is stopped, and the tail gate is closed.

The at least one further condition may include, in accordance with a preferred embodiment of the method, the execution of the opening command. In other words, the priority rules are defined such that the later closing command is ignored, if it is received during execution of the preceding opening command, i.e. during the opening of the vehicle door.

In an alternative embodiment of the method, the at least one further condition includes a time interval such that the later closing command is ignored if it is received within the time interval after receiving the preceding opening command.

In yet another embodiment of the method, the at least one further condition includes a section of the travel path of the vehicle door such that the later closing command is ignored if, at the time the later closing command is received, the vehicle door is in a position within the section of the travel path. Preferably, the section of the travel path is defined as being adjacent the closing position of the vehicle door. In this case, the later closing command is ignored if it is received while the vehicle door is positioned in the vicinity of its closed position. In this way, the risk of pinching or striking a person or an object which is most likely to happen when the vehicle door is near its closed position, can be minimized most efficiently.

Deviating from the principle that opening commands are processed with a higher priority than closing commands, in a further embodiment of the method, the priority rules are defined such that an opening command created by one of the command units is always overwritten by a closing command created by another one of the command units, if the closing command is received by the electric positioning device later than the opening command, and if the vehicle door is in a predefined section of the travel path adjacent the open position. In other words, closing commands are handled with a higher priority than opening commands, if the vehicle door is near its open position. The risk of the vehicle door colliding with an object while opening can thereby be minimized most efficiently.

In another embodiment of the invention there is provided a system including a plurality of command units and an electric positioning device for positioning a vehicle door. The electric positioning device acts on the vehicle door by using a motor for moving the vehicle door in an opening direction and a closing direction along a travel path between an open position and a closed position. The command units are connected to the positioning device for transmitting opening commands and closing commands to the electric positioning device for causing the electric positioning device to move the vehicle door in the respective opening direction or closing direction.

According to the invention the electric positioning device is operable to perform the method mentioned above. In other words, the electric positioning device is operable to process the commands upon receipt by virtue of a given set of priority rules, in dependence on the direction of movement of the vehicle door specified by the respective command.

In a preferred embodiment of the system, the electric positioning device is operable to execute, in accordance with the priority rules, the opening commands with a higher priority than the closing commands. Preferably, the priority rules are defined as detailed above with respect to the method.

In another preferred embodiment of the system, the electric positioning device includes an electronic control unit automatically performing the method mentioned above when operating. Preferably, the control unit is a programmable device, e.g. a microcontroller, in which the functionality to perform the method is implemented by using a software program (firmware). Alternatively, the control unit is constructed as a non-programmable electronic circuit such as an ASIC. In the latter case the functionality of the control unit to perform the method is implemented by hardware circuitry.

In a preferred embodiment of the invention, the vehicle door to be opened and closed by the electric positioning device is a tail gate of a passenger car. Therefore, the electronic positioning device includes an electric motor being mechanically coupled to the tail gate for moving the latter between its opened position and its closed position.

The plurality of command units preferably include one or more outer switches disposed at the tail gate, an inner switch disposed inside the car and a remote control device (e.g. a remote control button being provided at a car key). In accordance with the invention, the plurality of command units may further include a touch-free command unit being, preferably, realized by a capacitive approximation sensor configuration. Alternatively, the touch-free command unit may be realized as an ultrasound sensor configuration or as an optical sensor configuration.

Other features which are considered as characteristic for the invention are set forth in the appended claims.

Although the invention is illustrated and described herein as embodied in a method and a system for positioning a vehicle door, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic side-elevational view of a rear end of a passenger car with a tail gate being movable in an opening direction and a closing direction along a travel path between an open position and a closed position, and of a system including an electric positioning device for positioning the tail gate and a plurality of command units;

FIG. 2 is a flow chart of a first embodiment of a method for positioning the tail gate, in which the method is automatically performed by the system; and

FIG. 3 is a flow chart similar to FIG. 2 of a second embodiment of the method.

### DETAILED DESCRIPTION OF THE INVENTION

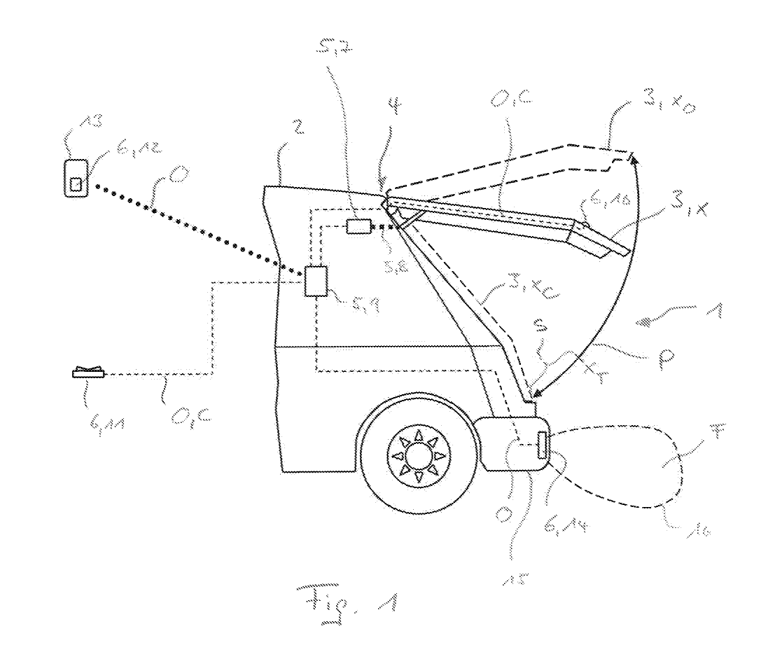

Referring now in detail to the figures of the drawings, in which the same or corresponding parts and quantities are always labeled with the same reference characters, and first, particularly, to FIG. 1 thereof, there is seen a diagrammatic illustration of a rear end 1 of a vehicle, i.e. a passenger car 2. The passenger car 2 is equipped with a movable vehicle door, the vehicle door being tail gate 3. The tail gate 3 is pivotably hinged to a top edge 4 of the rear end 1. The tail gate 3 can be moved by pivoting along a travel path P indicated by an arrow.

The travel path P is limited by a closed position x_{C} and an open position x_{O} of the tail gate 3, in which positions x_{C} and x_{O} the tail gate 3 is diagrammatically shown with dashed lines. The tail gate 3 is shown with continuous lines in an intermediate position x along the travel path P. It is pointed out that position x is understood to be an arbitrary position which the tail gate 3 may assume along its travel path P between its closed position x_{C} and its open position x_{O}. The open position x_{O} may be a stop position with crossing of that position being mechanically blocked. Alternatively, the open position x_{O} may be a programmed end position of the travel path P. In the latter case, preferably, the open position x_{O} can be varied by a car user. Thus, in a numerical sense, x_{C} and x_{O} are understood to denote constants, whereas x is understood to be a variable that may assume any value between x_{C} and x_{O} (x_{C}≦x≦x_{O}). For example, the position x may be counted in tenths of a degree of the opening angle of the tail gate 3. In this case, values 0 and 650 may be attributed to the closed position x_{C} and the open position x_{O}, respectively. Here, the position x can assume integer values between 0 and 650.

The passenger car 2 is equipped with a system including an electric positioning device 5 and a plurality of command units 6 for automatically positioning the tailgate 3.

The electric positioning device 5 includes an electric motor 7 being mechanically coupled, via an adjusting mechanism 8, with the tail gate 3 for moving the latter along the travel path P. The electric positioning device 5 further includes an electronic control unit 9. The control unit 9 is realized as a microcontroller in which a software program (firmware) is installed. It is electrically connected to the motor 7 for activating the latter.

The plurality of command units 6 are operable, by interaction with a user of the passenger car 2, to create opening commands O for causing the electric positioning device 5 to move the tail gate 3 in opening direction, and closing commands C for causing the electric positioning device 5 to move the tail gate 3 in closing direction. The command units 6 are connected, via wired or wireless connections, to the control unit 9 for transferring the commands O and C.

In particular, the command units 6 include an outer switch 10 being disposed at the outside of the tail gate 3. In the preferred embodiment of the system, the switch 10 is operable to create both opening commands O and closing commands C. To this end, the switch 10 may be configured as a toggle switch such that repeated activation of the switch 10 alternatingly triggers the creation of opening commands O and closing commands C. In an alternative embodiment of the system the command units 6 include two different outer switches for respectively creating opening commands O and closing commands C, instead of the single outer switch 10 shown in FIG. 1. One of the two outer switches, which is operable for creating opening commands O only, is disposed at the outside of the tail gate 3, similar to the outer switch 10 of FIG. 1. The other of the two outer switches, which is operable for creating closing commands C only, is disposed at the inner side of the outer edge of the tail gate 3. Thus, in the closed position x_{C} of the tail gate 3, the latter switch is hidden between the tail gate 3 and the car body. It is, however, exposed to a car user standing behind the car when the tail gate 3 is open. Preferably, the two outer switches are considered to constitute one command unit 6. The opening commands O and closing commands C created by theses two outer switches are handled by the electronic control unit 9 as if they were created by the single outer switch 10 shown in FIG. 1.

The command units 6 further include an inner switch 11 being disposed inside the passenger car 2 within reach of a car driver. In the preferred embodiment of the system the switch 11 is also operable to create both opening commands O and closing commands C. To this end, the switch 11 may be constructed as a three pole push button switch.

Additionally, the command units 6 include a remote control button 12 being provided at an electronic car key 13, and a touch-free command unit being realized as a capacitive approximation sensor configuration 14. The capacitive approximation sensor configuration 14 is disposed in a rear bumper 15 of the passenger car 2. In the preferred embodiment of the system, both the remote control button 12 and the capacitive approximation sensor configuration 14 are operable to create opening commands O only. Thus, the remote control button 12 and the capacitive approximation sensor configuration 14 can only be used for opening the tail gate 3, not for closing the same. However, in other embodiments of the invention, the remote control button 12 or the capacitive approximation sensor configuration 14 may also be provided for creating closing commands C.

In order to recognize an interaction of a car user signaling the user's intention to open the tail gate 3, the capacitive approximation sensor configuration 14 creates an electric field F in a space volume 16 outside the car 2 adjacent the bumper 15. In order to signal the intention to open the tail gate 3, the car user performs a kick in the direction of the bumper 15, in the course of which the user's foot shortly or briefly enters the space volume 16 thereby interacting with the electric field F. The capacitive approximation sensor configuration 14 detects the kick by monitoring the corresponding change of the electric field F and creates the opening command O upon detection of the kick.

The switches 10 and 11 and the capacitive approximation sensor configuration 14 are connected to the control unit 9 by wired electric connections. The remote control button 12 is connected to the control unit 9 by a wireless connection, in particular based on radio technology.

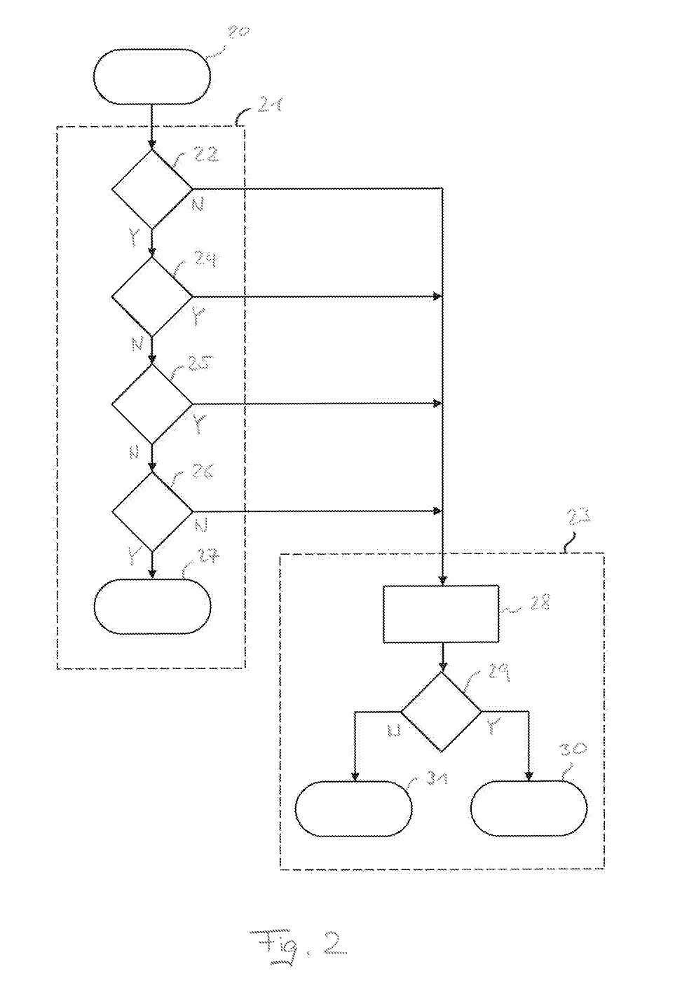

During operation, the control unit 9, under execution of the software program installed therein, automatically conducts a method which is more specifically illustrated in FIG. 2.

In a first step 20 of the method a command O,C, i.e. an opening command O or a closing command C created by one of the command units 6, is received by the control unit 9.

Subsequently, the control unit 9 starts a processing routine 21 based on predefined priority rules for processing opening commands O and closing commands C. In a first step 22 of the processing routine 21 the control unit 9 checks whether or not the tail gate 3 is moving, i.e. whether the motor 7 is activated. If not (N), the control unit 9 exits the processing routine 21 and starts an execution routine 23.

If so (Y), the control unit 9 checks in a second step 24 of the processing routine 21, whether or not the command O,C currently processed and a directly preceding command O,C have been created by the same command unit 6. If so (Y), the control unit 9 exits the processing routine 21 and starts the execution routine 23.

If not (N), i.e. if the command O,C currently processed and the preceding command O,C have been created by different command units 6, the control unit 9 checks in a third step 25 of the processing routine 21, whether the command O,C currently processed is an opening command O. If so (Y), the control unit 9 exits the processing routine 21 and starts the execution routine 23.

If not (N), i.e. in case the command O,C currently processed is a closing command C, the control unit 9 checks in a fourth step 26 of the processing routine 21, whether a timer (subsequently described) is running. If not (N), the control unit 9 exits the processing routine 21 and starts the execution routine 23.

If so (Y), the control unit 9 terminates the processing routine 21 in a fifth step 27 by ignoring the closing command C currently processed. In the preferred embodiment of the system, the control unit 9 terminates processing of the closing command C without any further action. If, during processing of the closing command C, the motor 7 has been activated to drive the tail gate 3 in the opening direction, the opening of the tail gate 3 will be continued without interruption or reversing. However, in alternative embodiments the method may be carried out such that, in step 27, the control unit 9 stops the motor 7 and, thus, halts the movement of the tail gate 3.

In a first step 28 of the execution routine 23, the control unit 9 starts the timer checked in step 26, with the timer running for a pre-defined time interval (e.g. 5 sec).

Thereafter, the control unit 9 checks in a second step 29 of the execution routine 23, whether or not the command O,C currently processed is an opening command O. If so (Y), the control unit 9, in a step 30, activates the motor 7 to move the tail gate 3 in the opening direction and terminates the execution routine 23.

If not (N), i.e. in case the command O,C currently processed is a closing command C, the control unit 9, in a step 31, activates the motor 7 to move the tail gate 3 in the closing direction and terminates the execution routine 23.

The method shown in FIG. 2 is repeated whenever a new command O,C is created by one of the command units 6 and transferred to the control unit 9. In the absence of intervening commands O,C the movement of the tail gate 3 started in steps 30 or 31 is continued until the tail gate 3 reaches its respective open position x_{O} or closed position x_{C}.

The steps 22 to 26 of the processing routine 21 define a set of priority rules, according to which opening commands O and closing commands C, under certain pre-defined conditions, are handled with different priorities, depending on the direction of movement specified.

To this end, step 25 of the processing routine 21 assures that a prior closing command C is overwritten with a later opening command O resulting in reversing the movement of the tail gate 3. On the other hand, steps 26 and 27 of the processing routine 21 assure that a later closing command C is ignored upon receipt during a time interval after having received a prior opening command O. The time interval is defined by the timer set in step 28 and checked in step 26 of the above-described method. In both cases mentioned above, opening commands O are handled with higher priority than closing commands C.

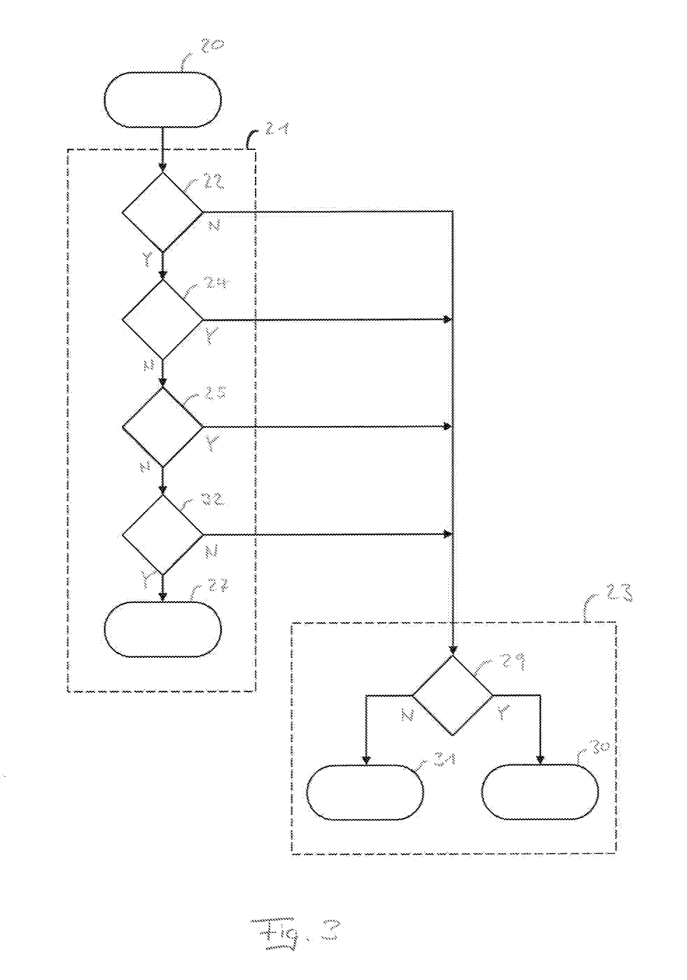

In another embodiment illustrated in FIG. 3, the software program installed in the control unit 9 is configured to conduct a modified version of the method outlined above.

Steps 20, 22, 24, 25, 27, 29, 30 and 31 of the method shown in FIG. 3 resemble the corresponding steps 20, 22, 24, 25, 27, 29, 30 and 31 of the method shown in FIG. 2. However, the method of FIG. 3 differs from the method of FIG. 2 in that step 26 is replaced by a step 32.

In step 32, the control unit 9 determines the current position x of the tail gate 3 and checks whether or not the position x is within a pre-defined section S (FIG. 1) of the travel path P. If not (N), the control unit 9 exits the processing routine 21 and starts the execution routine 23.

If so (Y), the control unit 9 proceeds to step 27 and terminates the processing routine 21 by ignoring the closing command C.

In the preferred embodiment, the section S is defined to be adjacent the closed position x_{C} of the tail gate 3. Thus, the control unit 9 determines the condition of step 32 as being fulfilled (Y), if the current position x of the tail gate 3 is found to be between the closed position x_{C} and a pre-defined threshold x_{T} (x_{C}≦x≦x_{T}).

Preferably, the threshold x_{T} is defined to be close to the closed position x_{C}. In the aforementioned embodiment in which the value of position x can vary between 0 and 650, preferably, the threshold x_{T} is selected between 30 and 80. For example, the threshold x_{T} may be set to 50, corresponding to an opening angle of the tail gate 3 of 5.

In the method according to FIG. 3, again opening commands O are handled with higher priority than closing commands C.

Due to this prioritization, the risk of a person or object being pinched, gripped or caught by the tail gate 3 is efficiently minimized, due to the fact that a movement of the tail gate 3 in the closing direction can be reversed any time via any of the command units 6. Coincidently, inconvenient situations arising from conflicting commands are avoided by the prioritization of the commands O,C, depending on the direction specified by the respective command O,C.

1. A method for positioning a vehicle door, the method comprising the following steps:
providing a vehicle door being movable in an opening direction and a closing direction along a travel path between an open position and a closed position;
creating at least one opening command and at least one closing command using at least one of a plurality of command units and transmitting the commands to an electric positioning device for causing the electric positioning device to move the vehicle door in the respective opening direction or closing direction; and
processing the commands upon receipt using the electric positioning device by virtue of a given set of priority rules, in dependence on the direction of movement of the vehicle door specified by the respective command.

2. The method according to claim 1, which further comprises executing the at least one opening command with a higher priority than the at least one closing command using the electric positioning device in accordance with the priority rules.

3. The method according to claim 1, which further comprises:
creating the closing command using one of the command units;
subsequently creating the opening command using another of the command units during execution of the closing command; and
overwriting the closing command with the opening command using the electric positioning device in accordance with the priority rules.

4. The method according to claim 1, which further comprises:
creating the opening command using one of the command units;
subsequently creating the closing command using another of the command units; and
ignoring the closing command by using the electric positioning device in accordance with the priority rules if, at a time that the closing command is received, at least one condition is met.

5. The method according to claim 4, wherein the at least one condition includes execution of the opening command such that the closing command is ignored if it is received during execution of the opening command.

6. The method according to claim 4, wherein the at least one condition includes a time interval such that the closing command is ignored if it is received within the time interval after receiving the opening command.

7. The method according to claim 4, which further comprises defining a section of the travel path of the vehicle door, and defining the at least one condition as ignoring the closing command if, at a time of receiving the closing command, the vehicle door is in a position within the section of the travel path.

8. The method according to claim 7, wherein the section of the travel path is adjacent the closed position of the vehicle door.

9. The method according to claim 4, which further comprises stopping execution of the opening command upon receipt of the closing command to stop the vehicle door, by using the electric positioning device in accordance with the priority rules.

10. The method according to claim 1, which further comprises:
creating the opening command using one of the command units;
subsequently creating the closing command during execution of the closing command by using another of the command units; and
overwriting the opening command with the closing command using the electric positioning device in accordance with the priority rules if, at a time that the closing command is received, the vehicle door is in a predefined section of the travel path adjacent the open position.

11. A system, comprising:
a plurality of command units and an electric positioning device configured to position a vehicle door;
a motor through which said electric positioning device acts on the vehicle door for moving the vehicle door in an opening direction and a closing direction along a travel path between an open position and a closed position;
said command units being connected to said electric positioning device for transmitting opening commands and closing commands to said electric positioning device to cause said electric positioning device to move the vehicle door in the respective opening direction or closing direction; and
said electric positioning device being operable to process each of said commands upon receipt by virtue of a given set of priority rules, in dependence on the direction of movement of the vehicle door specified by the respective command.

12. The system according to claim 11, wherein said electric positioning device is operable to execute, in accordance with said priority rules, said opening commands with a higher priority than said closing commands.

13. The system according to claim 11, wherein said electric positioning device is operable to overwrite, in accordance with said priority rules, a closing command created by one of said command units with an opening command created by another of said command units if said opening command is received by said electric positioning device during execution of said closing command.

14. The system according to claim 11, wherein said electric positioning device is operable to ignore, in accordance with said priority rules, a closing command created by one of said command units when said closing command is received later than an opening command created by another of said command units if, at a time that said closing command is received, at least one condition is met.

15. The system according to claim 14, wherein said at least one condition is an execution of said opening command such that said closing command is ignored if it is received during execution of said opening command.

16. The system according to claim 14, wherein said at least one condition is a time interval such that said closing command is ignored if it is received within said time interval after receiving said opening command.

17. The system according to claim 14, wherein said at least one condition is designating a section of the travel path of the vehicle door such that said closing command is ignored if, at a time that said closing command is received, the vehicle door is in a position within said section of the travel path.

18. The system according to claim 17, wherein said section of the travel path is adjacent the closing position of the vehicle door.

19. The system according to claim 14, wherein said electric positioning device is operable to stop, in accordance with said priority rules, an execution of said opening command upon receipt of said closing command such the vehicle door is stopped.

20. The system according to claim 1, wherein said electric positioning device is operable to overwrite, in accordance with said priority rules, an opening command created by one of said plurality of command units with a closing command created by another of said plurality of command units, when said closing command is received later than said opening command if, at a time that said closing command is received the vehicle door is in a predefined section of the travel path adjacent the open position.
